(19) United States
(12) Patent Application Publication
(10) Pub. No.: US 2026/0095536 A1
(43) Pub. Date: Apr. 2, 2026

(54) IMAGE PROCESSING APPARATUS AND IMAGE READING APPARATUS

(71) Applicant: CANON KABUSHIKI KAISHA, Tokyo (JP)

(72) Inventors: TAKUMA YOSHINO, Chiba (JP); SATOSHI YOSHIDA, Saitama (JP); KAORU HAMADA, Chiba (JP)

(21) Appl. No.: 19/331,422

(22) Filed: Sep. 17, 2025

(30) Foreign Application Priority Data
Sep. 27, 2024 (JP) 2024-169198

(51) Int. Cl. H04N 1/387; H04N 1/00

(52) U.S. Cl. CPC H04N 1/3878; H04N 1/00816

(57) ABSTRACT

In an image processing apparatus, a detection unit detects an end portion of a document image in a first direction and an end portion of the document image in a second direction orthogonal to the first direction, in a read image obtained by reading a document conveyed in the first direction. A computation unit determines a reference position for skew correction with respect to the read image by computing a corner position of the document image in the read image based on the detection result, a first resolution, which is a read resolution in the first direction in reading of the document, and a second resolution, which is a read resolution in the second direction in reading of the document. A correction unit performs the skew correction with respect to the read image with reference to the reference position.

### BACKGROUND

### Field of the Technology

The present disclosure relates to an image processing apparatus and an image reading apparatus.

### Description of the Related Art

In an image reading apparatus (document reading apparatus) including an auto document feeder (ADF), there is a case where a document is conveyed askew. When a skew occurs in the document, skew correction of the document is performed by a conveyance mechanism, for example. Alternatively, skew correction is performed by image processing on a read image obtained by reading a document by an image reading unit.

In the skew correction of the document by the image processing, rotational correction of rotating the read image with a reference position determined based on the read image as a reference (rotation center) is performed. Japanese Patent Laid-Open No. 2017-92562 discloses a method of determining, as a reference position for rotational correction, an intersection point in a case where a linear equation (straight line) representing inclination of a leading end portion of a document image in a read image and an end portion in a main scanning direction of the read image are connected by a normal. This can determine the reference position by estimating a corner position of the document image even if deterioration such as folding or tearing occurs at a corner of the document of a reading target.

However, if the read resolution in the main scanning direction and the read resolution in a sub-scanning direction are different from each other, a phenomenon in which the document image in the read image is distorted to an image having not a rectangular shape but a parallelogram shape occurs. In this case, in the above-described method, a deviation from an actual corner position of the document image occurs in a result of estimating a reference position serving as a reference of skew correction (rotational correction) with respect to the read image. This leads to occurrence of a defect or a margin in the document image after the skew correction.

### SUMMARY

The present disclosure provides a technique of preventing a decrease in accuracy of correction of a read image (document image) by skew correction even if a read resolution in a main scanning direction and a read resolution in a sub-scanning direction are different from each other.

According to one aspect of the present disclosure, there is provided an image processing apparatus comprising: a detection unit configured to detect an end portion of a document image in a first direction and an end portion of the document image in a second direction orthogonal to the first direction, in a read image obtained by reading a document conveyed in the first direction; a computation unit configured to determine a reference position for skew correction with respect to the read image by computing a corner position of the document image in the read image based on a result of detection by the detection unit, a first resolution, which is a read resolution in the first direction in reading of the document, and a second resolution, which is a read resolution in the second direction in reading of the document; and a correction unit configured to perform the skew correction with respect to the read image with reference to the reference position.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view illustrating a configuration example of an image reading apparatus 100.

FIG. 2 is a block diagram illustrating a configuration example of a controller 200.

FIG. 3 is an explanatory view of an edge detection range of an edge detection unit 205.

FIGS. 4A to 4C are explanatory views of edge detection results of the edge detection unit 205.

FIG. 5 is an explanatory view of a valid data range of an inclination computation unit 208.

FIG. 6 is an explanatory view of processing by a reference position computation unit 209.

FIGS. 7A to 7C are explanatory views of skew correction with respect to a read image.

FIGS. 8A and 8B illustrate acquisition examples of a reference position O.

FIGS. 9A and 9B illustrate examples of skew correction results.

FIG. 10 is an explanatory view of processing by a reference position correction unit 210.

FIGS. 11A to 11C are explanatory views of processing by a skew correction unit 211.

FIG. 12 is a flowchart showing an example of a processing procedure by the image reading apparatus.

FIG. 13 is a flowchart (variation example) showing an example of a processing procedure by the image reading apparatus.

FIG. 14 is an explanatory view of processing by the skew correction unit 211.

FIG. 15 illustrates an example of an output image of the skew correction unit 211.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Image Reading Apparatus

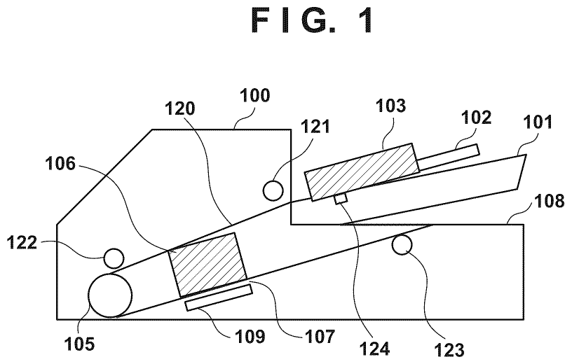

FIG. 1 is a cross-sectional view illustrating a configuration example of the image reading apparatus 100 including a document conveyance mechanism according to a first embodiment. The image reading apparatus 100 includes a document tray 101, a document conveyance motor 105, an image reading unit 106, and a paper discharge tray 108. One or more documents 102 having a rectangular shape are placed on the document tray 101. A paper feed roller 121, a conveyance roller 122, and a discharge roller 123 are provided along a conveyance path 120 of the document 102. The paper feed roller 121, the conveyance roller 122, and the discharge roller 123 are driven by the document conveyance motor 105.

The document tray 101 includes two document guides 103 arranged side by side in a direction orthogonal to the conveyance direction of the document 102. In the present description, the direction orthogonal to the conveyance direction of the document 102 may be referred to as a main scanning direction or a width direction of the document 102, and the conveyance direction of the document 102 may be referred to as a sub-scanning direction of the document 102. The two document guides 103 are slidable in the width direction of the document 102, and sandwich and align the document 102 placed on the document tray 101. The document tray 101 further includes a document detection sensor 124 for detecting the document 102 placed on the document tray 101.

The paper feed roller 121 takes the documents 102 placed on the document tray 101 one by one into the conveyance path 120. The conveyance roller 122 conveys, toward the image reading unit 106, the document 102 taken into the conveyance path 120 by the paper feed roller 121. A document background plate 109 is provided at a position opposing the image reading unit 106 with the conveyance path 120 in between. The image reading unit 106 forms a reading position 107 between the image reading unit 106 and the document background plate 109. The image reading unit 106 reads the document 102 when the document 102 having been conveyed on the conveyance path 120 by the conveyance roller 122 passes through the reading position 107. The document 102 read by the image reading unit 106 is discharged from the reading position 107 to the paper discharge tray 108 by the discharge roller 123.

### Configuration of Controller

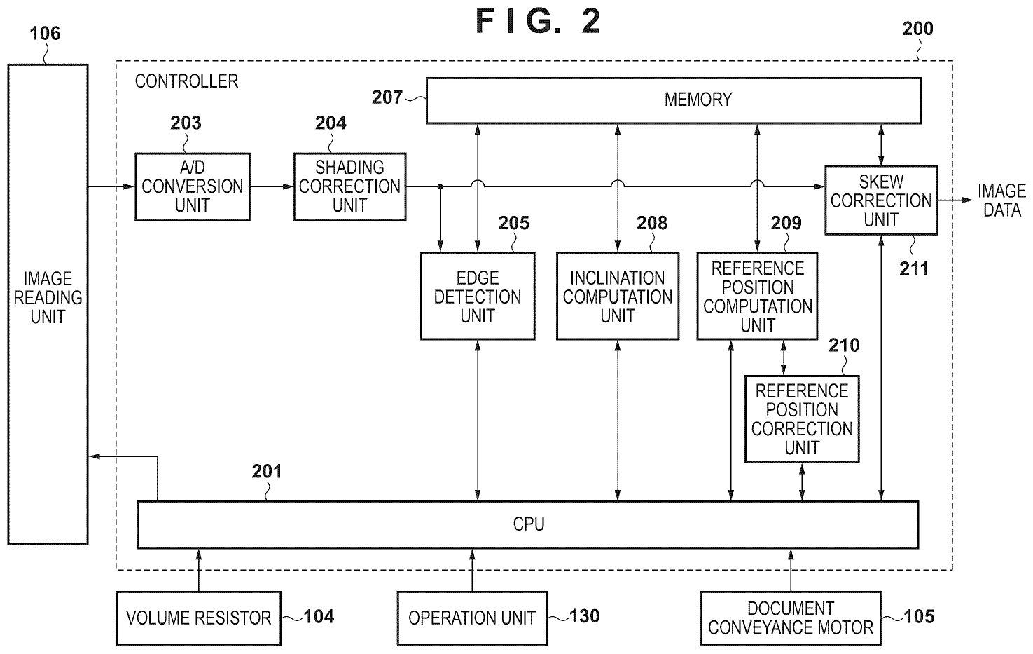

FIG. 2 is a block diagram illustrating a configuration example of the controller 200 configured to control the operation of the image reading apparatus 100. The image reading apparatus 100 incorporates the controller 200. The controller 200 includes a central processing unit (CPU) 201. The CPU 201 controls the entire operation of the image reading apparatus 100 by controlling the operation of each device in the controller 200. Note that the controller 200 of the present embodiment may be configured as an image processing apparatus configured to perform image processing with respect to a read image obtained by reading a document (by the image reading unit 106).

The controller 200 further includes an A/D conversion unit 203, a shading correction unit 204, the edge detection unit 205, and a memory 207. A plurality of processors or CPU cores may be included. The memory 207 is a storage apparatus including a read only memory (ROM), a random access memory (RAM), a solid state drive (SSD), and a hard disk drive (HDD). The controller 200 further includes the inclination computation unit 208, the reference position computation unit 209, the reference position correction unit 210, and the skew correction unit 211, and these are used for skew correction of the document.

The controller 200 is connected to the document conveyance motor 105 and the image reading unit 106. The controller 200 controls conveyance of the document 102 by the document conveyance motor 105 and reading of a document image by the image reading unit 106. The controller 200 is configured to acquire, from the image reading unit 106, analog image data representing the read image obtained by reading the document 102, and generate image data after image processing such as skew correction and shading correction. The image data generated by the controller 200 can be used for copying, facsimile transmission, transmission to a personal computer, and the like.

The controller 200 is further connected to a volume resistor 104 and detects a resistance value of the volume resistor 104. The volume resistor 104 is configured such that the resistance value varies depending on an interval between the two document guides 103 provided at the document tray 101. The controller 200 (CPU 201) detects the interval between the two document guides 103 based on the resistance value of the volume resistor 104. By detecting the interval between the two document guides 103, the controller 200 (CPU 201) detects the size in the width direction (direction orthogonal to the conveyance direction) of the document 102 placed on the document tray 101. In the present description, the size in the width direction of the document 102 is also referred to as a “document width”.

The controller 200 is connected to an operation unit 130. The operation unit 130 includes a display apparatus (e.g., a liquid crystal display) that outputs information to a user and an input apparatus (e.g., a touch panel sensor) that receives an instruction from the user. The input apparatus receives, for example, a start instruction for image reading processing, designation for a document size, an instruction for a reading mode, and the like from the user, and transmits input information indicating the received input to the controller 200. The display apparatus performs display and the like of a message or an operation screen under the control of the controller 200.

In the present embodiment, the CPU 201 determines resolutions (read resolutions) in the main scanning direction and the sub-scanning direction instructed by the user as settings for reading of the document. This determination result is used by the reference position correction unit 210 and the skew correction unit 211 described later. The CPU 201 performs image reading processing using the image reading unit 106 based on a user's instruction input from the operation unit 130.

The A/D conversion unit 203 converts image data in an analog form representing a read image output from the image reading unit 106 into image data in a digital form to output the image data in the digital form. The shading correction unit 204 performs shading correction with respect to the image data of the read image output from the A/D conversion unit 203. The shading correction is processing of correcting non-uniformity of the light amount of an LED light source in the image reading unit 106 and an influence of the pixel sensitivity of a CCD line sensor in the image reading unit 106.

The edge detection unit 205 detects an edge portion (of the document image) in the read image based on the image data having been subjected to the shading correction output from the shading correction unit 204, and generates edge information indicating the edge portion. The edge detection unit 205 stores the generated edge information into the memory 207. The edge detection unit 205 detects two edge portions in the main scanning direction (width direction) of the document image in the read image as a left main scanning edge position and a right main scanning edge position, and inputs them to the CPU 201. The left main scanning edge position corresponds to the position of the left end (left side) of the document image with respect to the conveyance direction of the document 102, and the right main scanning edge position corresponds to the position of the right end (right side) of the document image with respect to the conveyance direction. The edge detection unit 205 may detect the edge portion in the read image based on a threshold to be instructed from the CPU 201. Note that details of the processing performed by the edge detection unit 205 will be described later.

The inclination computation unit 208 computes a linear equation representing an inclination of the document image in the read image based on the left main scanning edge position or the right main scanning edge position detected by the edge detection unit 205. As described later, the computation is performed using a pixel group included in a valid data range having been set in the read image.

The reference position computation unit 209 computes and inputs, to the CPU 201, any one of positions of two front corners (corner positions) in the conveyance direction of the document 102 as a reference position at the time of skew correction of the read image. As described later, the reference position computation unit 209 performs estimation computation using the left main scanning edge position and a sub-scanning edge position of the document image and the linear equation obtained by the inclination computation unit 208 so as to be able to compute the reference position even when the end portion of the document 102 is deteriorated due to folding or the like.

The reference position correction unit 210 computes and inputs, to the CPU 201, a correction amount with respect to a deviation generated between the reference position (corner position) estimated by the reference position computation unit 209 and the actual corner position of the document image. As described later, the document image in the read image is distorted into a parallelogram shape when the read resolution in the main scanning direction (hereinafter, also referred to as “main scanning resolution”) at the time of reading the document 102, and the read resolution in the sub-scanning direction (hereinafter, also referred to as “sub-scanning resolution”) are different from each other. The corner position of the document image to be estimated by the reference position computation unit 209 deviates from the actual corner position when the document image is distorted into a parallelogram shape. In such a case, the reference position correction unit 210 performs a correction computation to obtain a correction amount for correcting the reference position for skew correction by a method described later. Note that as described later, the reference position correction unit 210 may be configured to output the correction amount as 0 or not to perform the correction computation when the main scanning resolution and the sub-scanning resolution are the same.

The skew correction unit 211 performs skew correction with respect to the read image by image processing with respect to the image data of the read image. The skew correction unit 211 performs skew correction with respect to the read image using the skew angle (skew amount) of the document image with respect to the main scanning direction and the correction amount of the reference position, and outputs an image after correction. Details of the skew correction by the skew correction unit 211 will be described later.

Each of the above-described units included in the controller 200 may be implemented by, for example, a hardware circuit such as an application-specific integrated circuit (ASIC), a field programmable gate array (FPGA), and an image processor. Alternatively, at least a part of the above-described units may be implemented as a part of the function of the CPU 201.

Hereinafter, details of processing performed by the edge detection unit 205, the inclination computation unit 208, the reference position computation unit 209, the reference position correction unit 210, and the skew correction unit 211 will be described.

### Edge Detection Unit

The edge detection unit 205 detects an edge portion (end portion) of the document image in the read image by performing edge detection processing on the image data after shading correction. The edge detection unit 205 detects the edge portion of the document image from the read image within a range set by the CPU 201 in the main scanning direction and the sub-scanning direction. The edge detection unit 205 can detect the edge portion of the document image by known first derivative, second derivative, Hough transformation, or the like. The edge detection unit 205 stores, in the memory 207, information (edge information) indicating the result of detecting the edge portion of the document image.

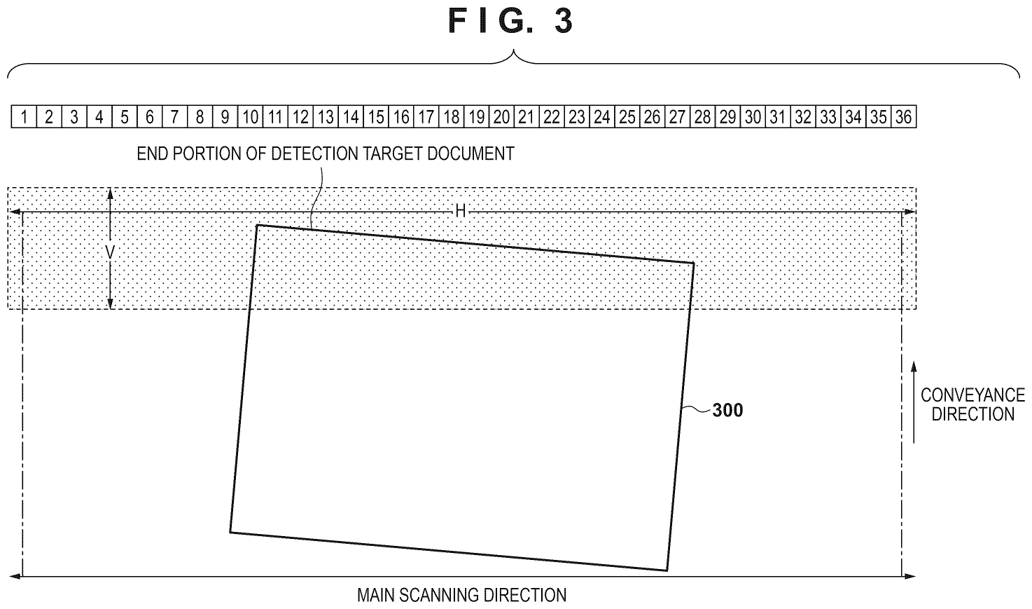

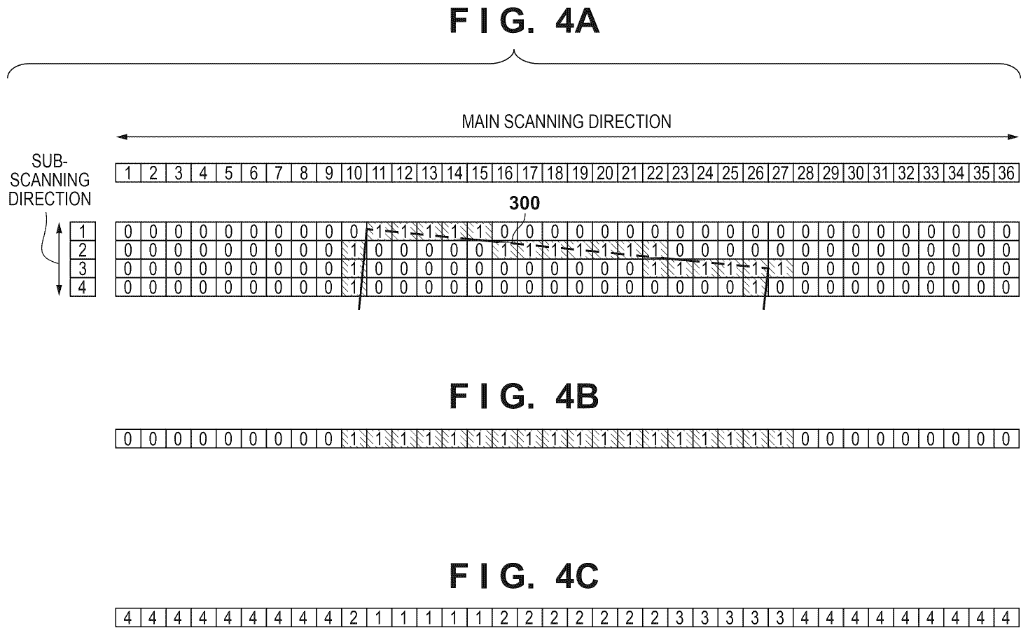

FIGS. 3 and 4A to 4C are explanatory views of edge detection processing for detecting a main scanning edge and a sub-scanning edge of the document image from the read image. In the edge detection processing, two edge portions (left end and right end) in the main scanning direction (width direction) of the document image are detected as a left main scanning edge position and a right main scanning edge position. An edge portion of the document leading end is detected as a sub-scanning edge position.

In FIGS. 3 and 4A to 4C, the left-right direction (horizontal direction) corresponds to the main scanning direction (width direction), and the up-down direction (vertical direction) corresponds to the sub-scanning direction (conveyance direction). In each drawing (as indicated by the arrow in FIG. 3), the upward direction corresponds to the conveyance direction of the document 102. Note that for the sake of explanation, the leftmost pixel is the first pixel, and the rightmost pixel is the 36th pixel in each drawing.

As illustrated in FIG. 3, in the present embodiment, the edge detection range by the edge detection unit 205 is determined by an edge detection range H in the main scanning direction and an edge detection range V in the sub-scanning direction. In the examples of FIGS. 3 and 4A to 4C, the edge detection range H in the main scanning direction has 36 pixels, and the edge detection range in the sub-scanning direction has 4 pixels. The edge detection range V in the sub-scanning direction is set such that the edge portion of the document image in the read image can be detected even when the document 102 is read by the image reading unit 106 in a state of being inclined with respect to the conveyance direction.

The edge detection unit 205 detects the edge portion of the document image within the edge detection range having been set. FIG. 4A illustrates an example of a result of detection by the edge detection unit 205. The edge detection unit 205 detects, as an edge portion, a pixel whose color has changed from the background color to another color, for example, in the read image in the main scanning direction or the sub-scanning direction. The edge detection unit 205 generates, as a detection result, an image (detection image) obtained by binarizing a pixel detected as an edge portion as “1” and a pixel not detected as an edge portion as “0”.

### Detection of Main Scanning Edge

The edge detection unit 205 performs a logical disjunction operation of pixel values over a plurality of pixels arranged in the sub-scanning direction for each position (main scanning position) in the main scanning direction in the detection image of FIG. 4A. This gives a computation result indicating the presence/absence of an edge portion of the document image for each position (pixel) in the main scanning direction as illustrated in FIG. 4B. A pixel in which an edge portion is detected is represented by “1”, and a pixel in which an edge portion is not detected is represented by “0”. For each position (pixel) in the main scanning direction, the result of the logical disjunction operation is “1” when any of the plurality of pixels arranged in the sub-scanning direction is “1”, and the result of the logical disjunction operation is “0” when all of the plurality of pixels are “0”. In the present example, the edge detection unit 205 detects that the left main scanning edge position is the position of the 10th pixel in the main scanning direction and the right main scanning edge position is the position of the 27th pixel in the main scanning direction.

### Detection of Sub-Scanning Edge

The edge detection unit 205 refers to the pixel value of each pixel in the sub-scanning direction for each main scanning position in the detection image of FIG. 4A, and detects, as a sub-scanning edge position, the position (pixel) of the edge portion where the pixel value changes from “0” to “1”. FIG. 4C illustrates an example of the result of detecting the sub-scanning edge at each main scanning position. As illustrated in FIG. 4C, the sub-scanning edge position at the position of the 10th pixel in the main scanning direction is detected as the position of the second pixel in the sub-scanning direction based on the detection image of FIG. 4A. The sub-scanning edge position at the position of the 27th pixel in the main scanning direction is detected as the position of the third pixel in the sub-scanning direction. Note that regarding the main scanning position where no edge portion is detected in the sub-scanning direction, the sub-scanning edge position is represented as a position of a Vth pixel (V=4 in the present example).

The edge detection unit 205 outputs, to the CPU 201, the information regarding the left main scanning edge position, the right main scanning edge position, and the sub-scanning edge position acquired in this manner. In the present embodiment, the left main scanning edge position and the right main scanning edge position are represented by position information of one pixel of the edge portion in the main scanning direction in the document image, and the sub-scanning edge position is represented by position information of a pixel group constituting the side of the document leading end.

### Inclination Computation Unit

In order to perform skew correction of the document with respect to the read image, information indicating the inclination of the leading end of the document (document image) with respect to the main scanning direction (width direction) is required. The inclination of the corresponding straight line of the document leading end is used as a correction amount when the rotational correction of the read image is performed for skew correction of the document. The intercept of the straight line is used to obtain the corner position (reference point) of the document.

The inclination computation unit 208 acquires the main scanning edge position and the sub-scanning edge position detected by the edge detection unit 205 from the CPU 201, and performs computation to obtain a linear equation (inclination and intercept) representing a straight line corresponding to the document leading end. This linear equation (inclination and intercept) is obtained by performing a general least square method or Hough transformation on a pixel group representing the document leading end.

In order to accurately obtain the inclination of the document leading end, it is desirable that a plurality of pixels constituting a pixel group representing the document leading end are linearly arranged. In a case where deterioration due to, for example, tearing or folding occurs at the corner position of the document of the reading target, the position of the pixel at the periphery of the corner position of the document can deviate from the straight line corresponding to the document leading end in the pixel group representing the document leading end. In such a case, when the pixel at the periphery of the corner position of the document is used in computation to obtain the inclination of the document leading end, an error between the inclination obtained by the computation and the actual inclination of the document leading end can increase. Therefore, when computing the inclination of the document leading end, it is necessary to set a range excluding the periphery of the corner position of the document as a valid data range for acquiring data used for the computation and perform the computation.

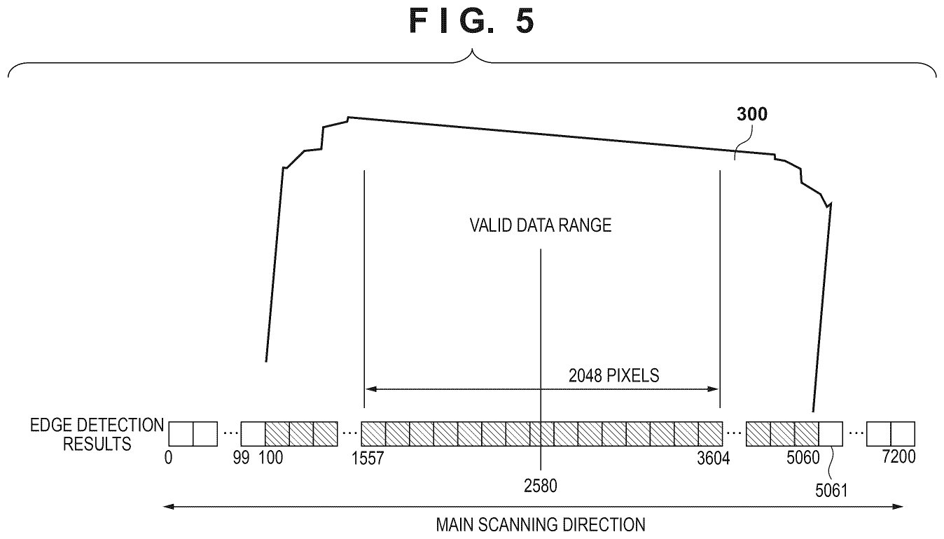

FIG. 5 illustrates a determination example of the above-described valid data range. Based on the left main scanning edge position and the right main scanning edge position detected by the edge detection unit 205, the inclination computation unit 208 determines the center position and the image length of the document image in the main scanning direction as follows.

$$Center position = ( left main scanning edge position ) + ( right main scanning edge position ) / 2$$

$$Image length = ( ( right main scanning edge position ) - ( main scanning edge position ) )$$

From the edge detection result, the inclination computation unit 208 acquires the values of a predetermined number of pixels centered on the center position within the range of the image length in the main scanning direction (between the right main scanning edge position and the left main scanning edge position). The range of the predetermined number of pixels centered on the center position in the main scanning direction corresponds to the valid data range illustrated in FIG. 5.

In the example of FIG. 5, the number of pixels in the main scanning direction is 7200 pixels, the leftmost pixel is the first pixel, and the rightmost pixel is the 7200th pixel. The edge detection unit 205 detects that the left main scanning edge position is the position of the 100th pixel and the right main scanning edge position is the position of the 5060th pixel. In this case, the center position of the document image in the main scanning direction is the position of the 2580th pixel, and the image length in the main scanning direction is 4960 pixels. In the example of FIG. 5, a range of 2048 pixels (the 1557th to 3604th pixels) in the main scanning direction is set as the valid data range centered on the center position (the position of the 2580th pixel) of the document image.

The inclination computation unit 208 computes (an inclination a and an intercept C, which are parameters of) a linear equation representing a straight line corresponding to the document leading end based on the sub-scanning edge position in the valid data range detected by the edge detection unit 205. The linear equation is expressed by (y=ax+C). The inclination a corresponds to an inclination angle (skew angle) of the document 102 with respect to the main scanning direction. The result of computing the parameters of the straight line corresponding to the document leading end is output to the CPU 201. Note that the skew angle may be referred to as a skew amount.

### Reference Position Computation Unit

Next, processing performed by the reference position computation unit 209 will be described. The reference position computation unit 209 computes any one of the positions (corner positions) of two corner portions on the front side of the conveyance direction in the document image in the read image as a reference position for skew correction with respect to the read image. Hereinafter, an example in which the corner position on the left side of the two corner positions on the front side of the conveyance direction of the document image is computed as the reference position will be described. Note that the reference position computation unit 209 may compute any one of the two corner positions as the reference position in accordance with an instruction from the CPU 201.

When the end portion of the document 102 is deteriorated due to folding or the like, it is difficult to correctly determine the corner position of the document image from the edge detection result of the edge detection unit 205. Therefore, the reference position computation unit 209 obtains the corner position of the document image by estimation computation using the left main scanning edge position and the sub-scanning edge position of the document image detected by the edge detection unit 205 and the linear equation obtained by the inclination computation unit 208.

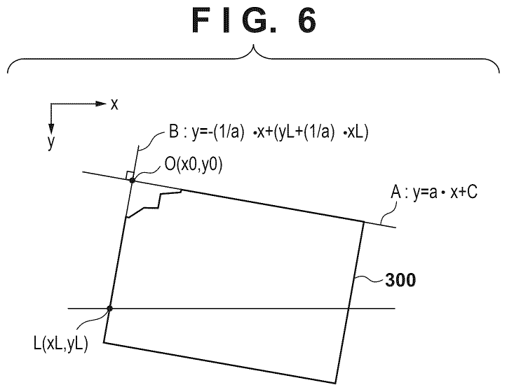

FIG. 6 illustrates an example of computation processing of the reference position. In the present example, the document is read at a main scanning resolution of 600 dpi and a sub-scanning resolution of 600 dpi. In FIG. 6, a position L (xL, yL) is the left main scanning edge position detected by the edge detection unit 205, where xL represents an x coordinate and yL represents a y coordinate. Note that an x axis direction corresponds to the main scanning direction, and a y axis direction corresponds to the sub-scanning direction. A straight line A corresponds to a linear equation obtained by the inclination computation unit 208 and is a straight line having the inclination a and the intercept C. A straight line B is a normal passing through the left main scanning edge position L and orthogonal to the straight line A. The linear equation representing the straight line B is obtained based on the left main scanning edge position L and the inclination a of the straight line A. An intersection point of the straight line A and the straight line B corresponds to the corner position of the document image, and is used as a reference position O for performing skew correction of the read document.

Assuming that the x coordinate of the reference position O is x0 and the y coordinate is y0, the reference position O (x0, y0) illustrated in FIG. 6 is obtained using the following Expressions (1) and (2).

$${x}_{O} = \frac{a}{{a}^{2} + 1} ( {y}_{L} + \frac{1}{a} \cdot {x}_{L} - C ) \qquad ( 1 )$$

$${y}_{O} = \frac{{a}^{2}}{{a}^{2} + 1} ( {y}_{L} + \frac{1}{a} \cdot {x}_{L} - C ) + C \qquad ( 2 )$$

According to Expressions (1) and (2), the reference position O (x0, y0) is obtained using the inclination a and the intercept C of the straight line A obtained by the inclination computation unit 208 and the left main scanning edge position L (xL, yL) detected by the edge detection unit 205. In this manner, even if the end portion of the document 102 is deteriorated, it is possible to compute the corner position of the document image as the reference position based on the edge position detected by the edge detection unit 205 and the parameter of the straight line A representing the document leading end obtained by the inclination computation unit 208.

### Influence of Error of Reference Position

Next, an error occurring at the reference position computed by the reference position computation unit 209 and the influence thereof will be described.

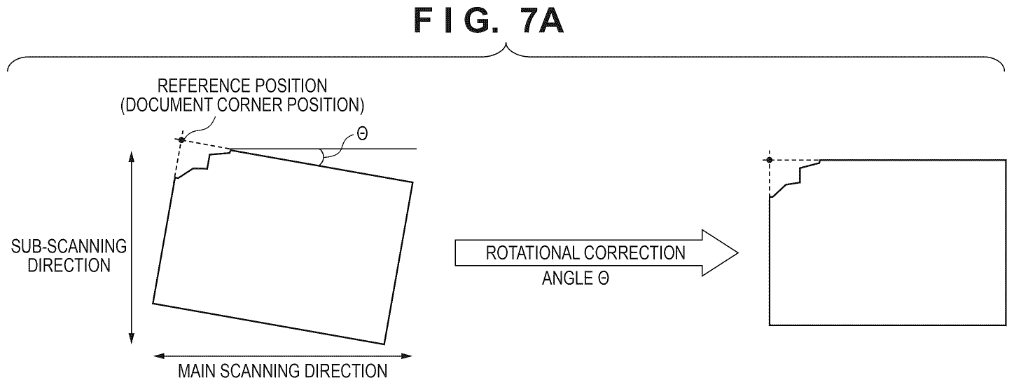

FIG. 7A illustrates an example of skew correction with respect to the document image (read image) in a case where the main scanning resolution and the sub-scanning resolution at the time of reading the document 102 are equal. In the example of FIG. 7A, distortion described later does not occur in the document image in the read image obtained when the document in which skew has occurred is read. Therefore, it is possible to perform skew correction with respect to the document image by performing rotational correction of the document image (read image) by an inclination angle (skew angle) @ of the document image with respect to the main scanning direction.

FIGS. 7B and 7C illustrate examples of skew correction with respect to the document image (read image) in a case where the main scanning resolution and the sub-scanning resolution at the time of reading the document 102 are different. FIG. 7B illustrates a case where the main scanning resolution is smaller than the sub-scanning resolution, and FIG. 7C illustrates a case where the main scanning resolution is larger than the sub-scanning resolution. In the example of FIGS. 7B and 7C, the document image in the read image obtained when the document in which the skew has occurred is read is distorted into the parallelogram shape due to the difference between the main scanning resolution and the sub-scanning resolution. In this case, unlike the example of FIG. 7A, performing only the rotational correction of the inclination angle (skew angle) @ of the document image with respect to the document image (read image) is not sufficient for correction into a document image (read image) having a rectangular shape. In order to convert an image having a parallelogram shape into an image having a rectangular shape, shear correction is required for an inclination angle Θ ′ of the parallelogram.

In this manner, in a case where the document in which skew has occurred is read with the reading setting in which the main scanning resolution and the sub-scanning resolution are different from each other, it is necessary to perform not only the rotational correction but also the shear correction with respect to the document image (read image). In general, both the rotational correction and the shear correction can be performed using affine transformation based on the reference position illustrated in FIGS. 7A to 7C.

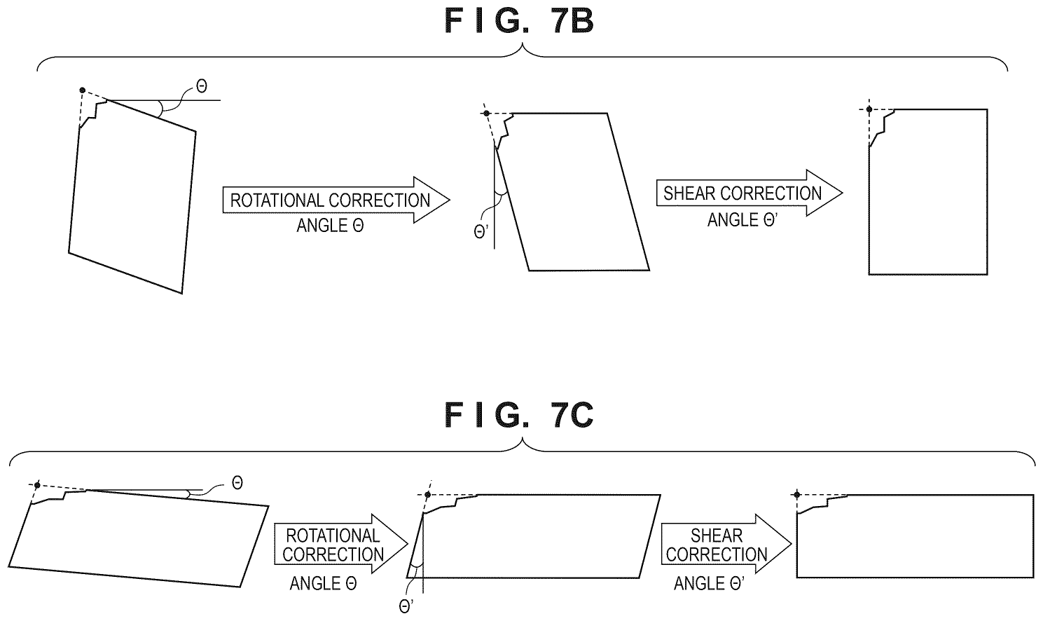

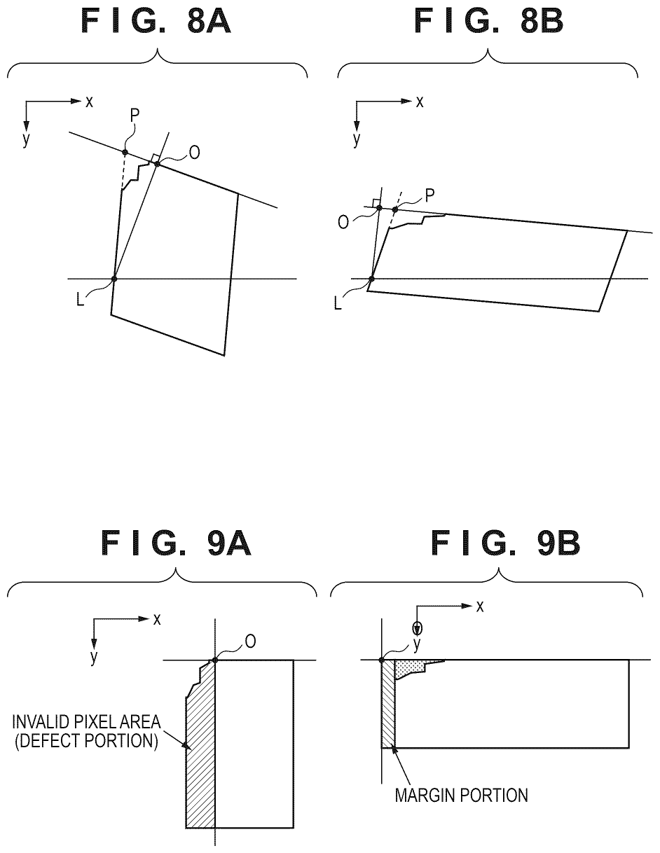

Next, acquisition examples of the reference position O by computation using Expressions (1) and (2) in a case where the main scanning resolution and the sub-scanning resolution are different from each other will be described with reference to FIGS. 8A, 8B, 9A, and 9B.

FIG. 8A illustrates the reference position O to be acquired (computed) from the read image when the document is read at the main scanning resolution of 300 dpi and the sub-scanning resolution of 600 dpi. In this case, since the main scanning resolution is smaller than the sub-scanning resolution, the document image in the read image has a parallelogram shape. When the reference position O is computed from this read image, a position different from a corner position P of the document image is acquired as the reference position O as illustrated in FIG. 8A.

FIG. 9A illustrates a correction result in a case where the rotational correction and the shear correction with the reference position O illustrated in FIG. 8A as a reference (rotation center) are applied to the read image. When a deviation (error) from the corner position P of the document image occurs at the reference position O, the controller 200 (CPU 201) erroneously recognizes the reference position O as the corner position of the document image in the read image. As a result, a hatched area in FIG. 9A is determined to be an invalid pixel area, whereby a defect occurs in a finally acquired document image.

FIG. 8B illustrates the reference position O to be acquired (computed) from the read image when the document is read at the main scanning resolution of 600 dpi and the sub-scanning resolution of 300 dpi. In this case, since the sub-scanning resolution is smaller than the main scanning resolution, the document image in the read image has a parallelogram shape similarly to the example of FIG. 8A. When the reference position O is computed from this read image, a position different from a corner position P of the document image is acquired as the reference position O as illustrated in FIG. 8B.

FIG. 9B illustrates a correction result in a case where the rotational correction and the shear correction with the reference position O illustrated in FIG. 8B as a reference (rotation center) are applied to the read image. When a deviation (error) from the corner position P of the document image occurs at the reference position O, the controller 200 (CPU 201) erroneously recognizes the reference position O as the corner position of the document image in the read image. As a result, a hatched margin area in FIG. 9B is also determined to be a part of the document image, whereby a margin occurs in a finally acquired document image.

In this manner, in a case where the main scanning resolution and the sub-scanning resolution are different from each other, when the reference position O is acquired by the computation using Expressions (1) and (2), the reference position O deviates from the actual corner position P of the document image. As a result, a document image (read image corresponding to the document) in which a defect or a margin has occurred is acquired. Therefore, in the present embodiment, as described below, processing of correcting the reference position O by the reference position correction unit 210 is performed so that the reference position for the rotational correction and the shear correction with respect to the read image is set at the corner position P of the document image.

### Reference Position Correction Unit

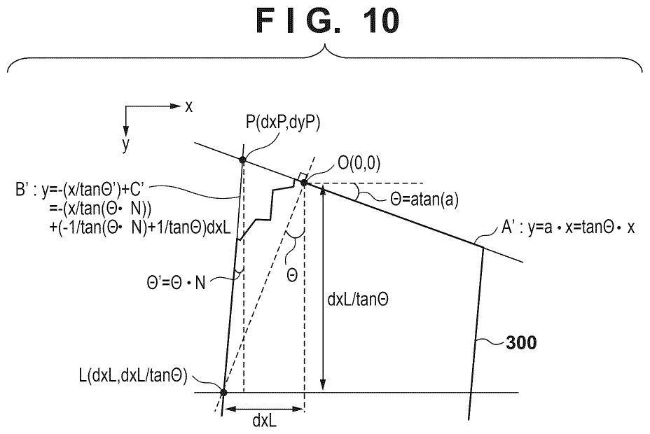

FIG. 10 illustrates an acquisition example of a correction amount (dxP, dyP) for correcting the reference position O acquired by the reference position computation unit 209. FIG. 10 illustrates the periphery of the corner position on the left side of the document leading end. In the present example, similarly to the example of FIG. 8A, a case is assumed in which the document is read at the main scanning resolution of 300 dpi and the sub-scanning resolution of 600 dpi.

The position O illustrated in FIG. 10 indicates a reference position acquired (computed) by the reference position computation unit 209, and the position P indicates an assumed corner position in the actual document image. The reference position correction unit 210 obtains a deviation amount between the position O and the position P acquired by the reference position computation unit 209, and uses the deviation amount as the correction amount of the reference position. Therefore, the deviation amount between the position O and the position P is acquired by obtaining coordinates (dxP, dyP) of the position P with the position O as the origin.

As illustrated in FIG. 10, the coordinates of the position P with the position O as the origin are obtained as coordinates of an intersection point of a straight line A′ corresponding to the document leading end and a straight line B′ corresponding to the document left end. Since the straight line A′ passes through the origin (position O), the linear equation representing the straight line A′ is expressed using only the inclination a acquired by the inclination computation unit 208, and the intercept C is not used. When the inclination angle (skew angle of the document image) of the straight line A′ with respect to the main scanning direction (x axis direction) is Θ, the skew angle Θ is determined with a=tan Θ.

$$Θ = {tan}^{- 1} ( a ) \qquad ( 3 )$$

The position L illustrated in FIG. 10 indicates the left main scanning edge position of the document image. Assuming that the x coordinate of the position Lis dxL, the coordinates of the position L are expressed as L (dxL, dxL/tan Θ). Since the numerical value of dxL is a relative value with respect to the coordinate O, dxL can be obtained as a difference between the x coordinate of the reference position O acquired by the reference position computation unit 209 and the x coordinate of the left main scanning edge coordinate L detected by the edge detection unit 205 as in the following expression.

It can be obtained by:

$$d x L = x 0 - x L \qquad ( 4 )$$

The angle Θ′ illustrated in FIG. 10 represents the angle of an end portion (left end) in the main scanning direction of the document image in the read image with respect to the sub-scanning direction (conveyance direction of the document 102). The angle Θ′ is obtained as Θ′=Θ·N by multiplying the skew angle Θ by a skew correction coefficient N. The skew correction coefficient N is obtained by the following expression based on the main scanning resolution and the sub-scanning resolution.

$$N = {( main scanning resolution / sub - scanning resolution )}^{2} \qquad ( 5 )$$

Note that as known from Expression (5), when the main scanning resolution and the sub-scanning resolution are equal to each other, N=1, and Θ′=Θ.

As illustrated in FIG. 10, the linear equation representing the straight line B′ is obtained as a linear equation representing a straight line having an inclination 1/tan Θ′ and passing through the position L. The coordinates (dxP, dyP) of the position P of the intersection point of the straight line A′ and the straight line B′ are obtained as the following expressions with

$${A}^{′} = {B}^{′}$$

$$tan Θ \cdot {dx}_{P} = - \frac{d {x}_{P}}{tan ( Θ \cdot N )} + \{ - \frac{1}{tan ( Θ \cdot N )} + \frac{1}{tan Θ} \} d {x}_{L}$$

$${dx}_{P} = \frac{- tan Θ + tan ( Θ \cdot N )}{tan Θ \{ tan Θ \cdot tan ( Θ \cdot N ) + 1 \}} \cdot {dx}_{L} \qquad ( 6 )$$

$${dy}_{P} = \frac{- tan Θ + tan ( Θ \cdot N )}{\{ tan Θ \cdot tan ( Θ \cdot N ) + 1 \}} \cdot {dx}_{L} \qquad ( 7 )$$

According to Expressions (6) and (7), the correction amount (dxP, dyP) with respect to the reference position O is obtained based on (the x coordinate dxL of) the left main scanning edge position L, the skew angle Θ of the document image, and the skew correction coefficient N determined based on the main scanning resolution and the sub-scanning resolution.

### Skew Correction Unit

The skew correction unit 211 performs skew correction with respect to the read image by image processing with respect to the image data of the read image in accordance with an instruction from the CPU 201. The skew correction unit 211 performs the skew correction with respect to the read image using the reference position O (first reference position) acquired by the reference position computation unit 209, the skew angle Θ of the document image with respect to the main scanning direction acquired by the reference position correction unit 210, and the correction amount (dxP, dyP) of the reference position.

As described above, in a case where the document in which skew has occurred is read with the reading setting in which the main scanning resolution and the sub-scanning resolution are different from each other, distortion of deformation into a parallelogram shape occurs in the read image (document image) due to the difference between the main scanning resolution and the sub-scanning resolution. In order to compensate for such distortion, it is necessary to perform not only rotational correction but also shear correction with respect to the read image (document image).

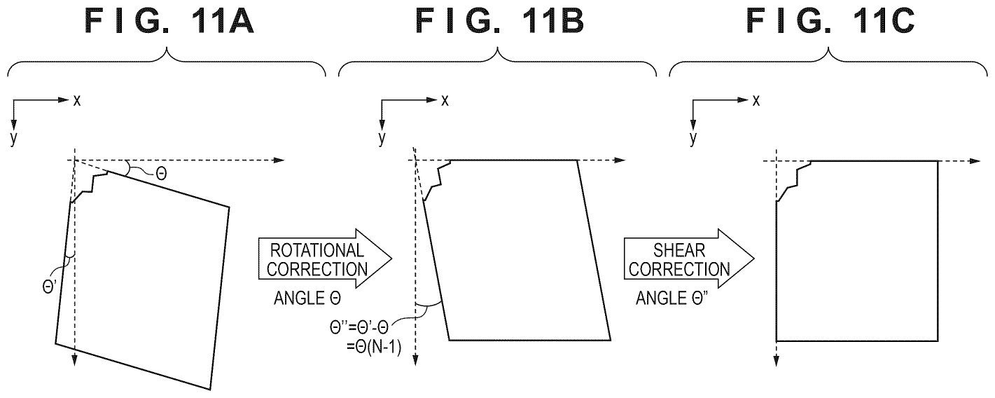

In the present embodiment, affine transformation is used for rotational correction processing and shear correction processing. FIG. 11A illustrates a reading result (document image in the read image) of the document 102 in a case where the document in which skew has occurred is read with the reading setting in which the main scanning resolution and the sub-scanning resolution are different from each other. The coordinate transformation of each pixel in the document image by the rotational correction processing with respect to the document image illustrated in FIG. 11A is expressed by the following expression.

$$( \begin{matrix}{x}^{′} \\ {y}^{′}\end{matrix} ) = ( \begin{matrix}cos Θ & - sin Θ \\ sin Θ & cos Θ\end{matrix} ) ( \begin{matrix}x \\ y\end{matrix} ) \qquad ( 8 )$$

Here, each parameter in Expression (8) is defined as follows.
x: Pixel position before rotational correction (main scanning direction)
y: Pixel position before rotational correction (sub-scanning direction)
x′: Pixel position after rotational correction (main scanning direction)
y′: Pixel position after rotational correction (sub-scanning direction)
Θ: Skew angle with respect to main scanning direction of document leading end

FIG. 11B illustrates a result of performing rotational correction with respect to the document image illustrated in FIG. 11A. Since distortion of deformation into a parallelogram shape occurs in the document image after the rotational correction, it is necessary to compensate for such distortion by the shear correction processing. The coordinate transformation of each pixel in the document image by the shear correction processing with respect to the document image illustrated in FIG. 11B is expressed by the following expression.

$$( \begin{matrix}{x}^{′} \\ {y}^{′}\end{matrix} ) = ( \begin{matrix}1 & tan {Θ}^{′′} \\ 0 & 1\end{matrix} ) ( \begin{matrix}x \\ y\end{matrix} ) \qquad ( 9 )$$

Here, each parameter in Expression (9) is defined as follows.
x: Pixel position before shear correction (main scanning direction)
y: Pixel position before shear correction (sub-scanning direction)
x′: Pixel position after shear correction (main scanning direction)
y′: Pixel position after shear correction (sub-scanning direction)
Θ″: Skew angle of parallelogram indicated by document image after rotational correction

Note that as illustrated in FIG. 11B, the skew angle Θ″ is obtained as Θ″=Θ (N−1) based on the skew angle Θ with respect to the main scanning direction of the document leading end and the skew correction coefficient N.

FIG. 11C illustrates a result of performing the shear correction with respect to the document image illustrated in FIG. 11B. The document image after the shear correction is an image having a rectangular shape, and it is known that the above-described distortion has been compensated. In this manner, by applying the coordinate transformation of Expressions (8) and (9) to the read image (document image), it is possible to perform skew correction of the read image while compensating for distortion occurring in the read image due to the difference between the main scanning resolution and the sub-scanning resolution.

The skew correction of performing the rotational correction processing by Expression (8) and the shear correction processing by Expression (9) is expressed by the following expression.

$$( \begin{matrix}{x}^{′} \\ {y}^{′}\end{matrix} ) = ( \begin{matrix}cos Θ & - sin Θ \\ sin Θ & cos Θ\end{matrix} ) ( \begin{matrix}1 & tan Θ ( N - 1 ) \\ 0 & 1\end{matrix} ) ( \begin{matrix}x - {dx}_{p} \\ y - {dy}_{p}\end{matrix} ) \qquad ( 10 )$$

Here, each parameter in Expression (10) is defined as follows.
x: Pixel position before correction (main scanning direction)
y: Pixel position before correction (sub-scanning direction)
x′: Pixel position after correction (main scanning direction)
y′: Pixel position after correction (sub-scanning direction)
Θ: Skew angle with respect to main scanning direction of document leading end
N: Skew correction coefficient
dxP: Correction amount of reference position (main scanning direction)
dyP: Correction amount of reference position (sub-scanning direction)

In this manner, the skew correction unit 211 acquires the skew angle Θ of the document leading end, the skew correction coefficient N, the reference position O, and the correction amount (dxP, dyP) of the reference position, and applies them to Expression (10), thereby performing skew correction with respect to the read image (document image). This can perform skew correction by rotational correction and shear correction of the read image while correcting the reference position O for the skew correction.

### Processing Procedure

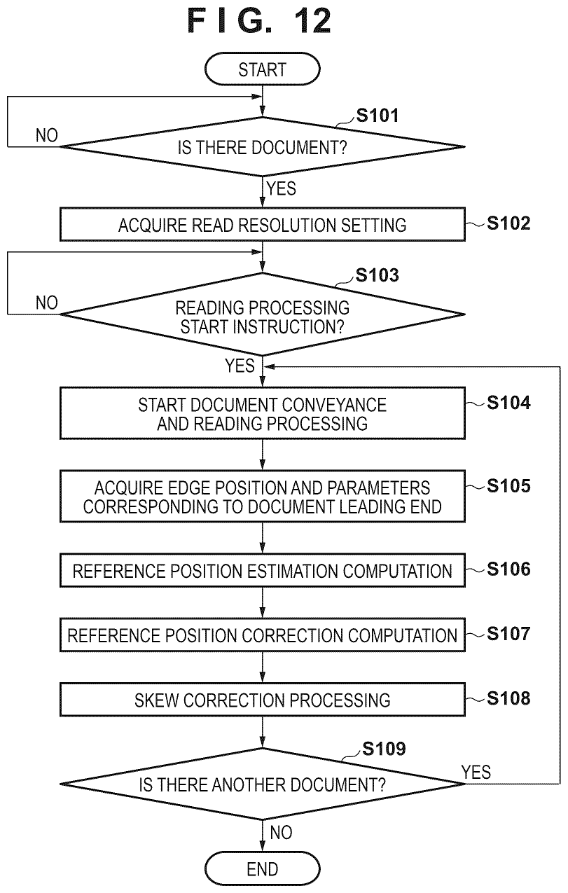

FIG. 12 is a flowchart showing an example of a procedure of processing to be executed by the image reading apparatus 100 of the present embodiment. The present processing includes image reading processing of reading a document to generate image data of a read image and skew correction processing with respect to the read image, and is executed by the CPU 201.

The CPU 201 determines the presence/absence of the document 102 on the document tray 101 in S101, and proceeds to S102 upon determining that the document 102 is present. This determination is executed based on the detection value output from the document detection sensor 124. For example, the document detection sensor 124 outputs a detection value of “0” in a state where the document 102 is not detected on the document tray 101, and outputs a detection value of “1” upon detecting the document 102. The CPU 201 determines that there is no document when the detection value is “0”, and determines that there is a document when the detection value is “1”.

In S102, the CPU 201 acquires the setting of the read resolution (main scanning resolution and sub-scanning resolution) based on the setting input from the operation unit 130 by the user. Thereafter, upon determining in S103 that an instruction to start the image reading processing has been received by pressing a start button of the operation unit 130, the CPU 201 proceeds to S104.

In S104, the CPU 201 controls the document conveyance motor 105 and the image reading unit 106 to start the conveyance of the document 102 and the reading operation of the document 102 by the image reading unit 106. By this, every time the document 102 is conveyed to the reading position 107 of the image reading unit 106, a read image corresponding to the document 102 is generated. In S105, the CPU 201 acquires the left main scanning edge position L (xL, yL) and the parameter values (the inclination a and the intercept C) of the linear equation corresponding to the document leading end (the end portion in the conveyance direction) regarding the document image in the read image by the edge detection unit 205 and the inclination computation unit 208.

Next, in S106, the CPU 201 executes the computation for estimating the reference position O (xO, yO) by the reference position computation unit 209 based on the information acquired in S105. Upon acquiring the result of estimating the reference position O (xO, yO), the CPU 201 performs in S107, by the reference position correction unit 210, a computation (correction computation) for acquiring the correction amount (dxP, dyP) for correcting an error of the reference position O that occurs when the main scanning resolution and the sub-scanning resolution are different from each other. As described above, the computation by the reference position correction unit 210 uses the left main scanning edge position L, the skew angle Θ of the document image, and the skew correction coefficient N determined based on the main scanning resolution and the sub-scanning resolution. The computation result by the reference position correction unit 210 is output from the reference position correction unit 210 to the skew correction unit 211. In S108, the CPU 201 performs, by the skew correction unit 211, the skew correction using Expression (10) with respect to the image data of the read image (image data after the shading correction).

Thereafter, in S109, the CPU 201 determines whether or not there is another document 102 on the document tray 101 based on the detection value output from the document detection sensor 124, and returns to S104 when there is another document. When there is no next document, the CPU 201 ends the processing according to the procedure of FIG. 12.

### Variation Example

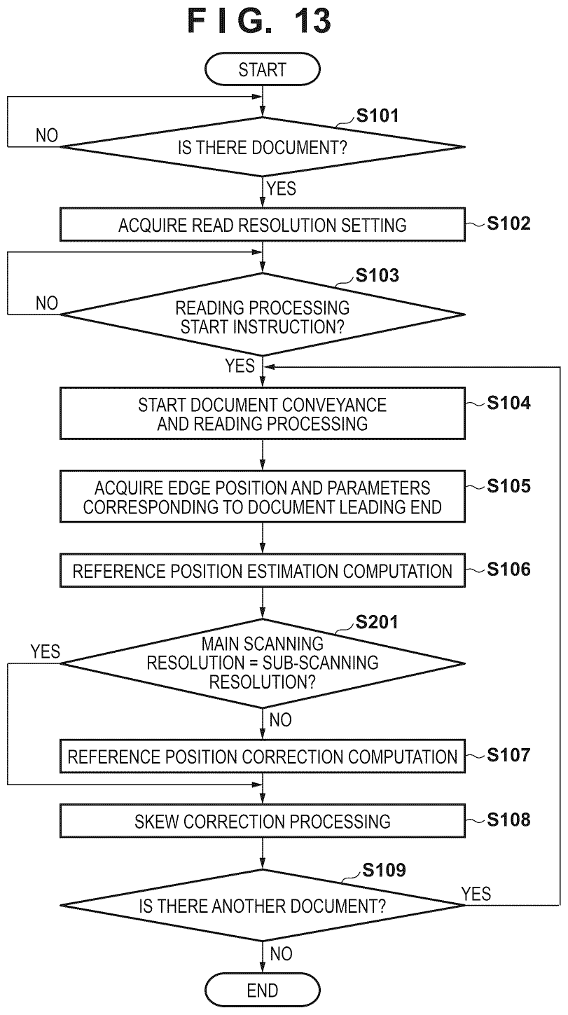

The above-described processing procedure can be varied. For example, in the above-described processing procedure, the correction computation (S107) for acquiring the correction amount (dxP, dyP) with respect to the reference position O by the reference position correction unit 210 may be performed only when the main scanning resolution and the sub-scanning resolution are different from each other. FIG. 13 shows an example of a processing procedure in such a case. In the processing procedure of FIG. 13, the processing of S101 to S106 is similar to that of FIG. 12. In the present example, upon acquiring the result of estimating the reference position O (xO, yO) in S106, the CPU 201 proceeds to S201.

In S201, the CPU 201 compares the main scanning resolution and the sub-scanning resolution acquired in S102, and if they match, the CPU 201 proceeds to S108, thereby skipping the correction computation in S107. In this case, in S108, skew correction is performed with the correction amount (dxP, dyP)=(0, 0). On the other hand, only when the main scanning resolution and the sub-scanning resolution are different from each other, the CPU 201 proceeds from S201 to S107, and performs the correction computation by the reference position correction unit 210 in S107, thereby acquiring the correction amount (dxP, dyP).

As described above, in the image reading apparatus (image processing apparatus) of the present embodiment, the image reading unit 106 reads a document conveyed in the first direction (conveyance direction) to generate a read image. The edge detection unit 205 detects the end portion of the document image in the first direction and the end portion of the document image in the second direction (main scanning direction) orthogonal to the first direction in the read image obtained by reading the document conveyed in the first direction. The reference position computation unit 209 and the reference position correction unit 210 determine the reference position for skew correction with respect to the read image by computing the corner position of the document image in the read image based on the result of detection by the edge detection unit 205, the first resolution (sub-scanning resolution), which is the read resolution in the first direction in reading the document, and the second resolution (sub-scanning resolution), which is the read resolution in the second direction in reading the document. The skew correction unit 211 performs skew correction with respect to the read image with reference to the determined reference position.

According to the present embodiment, even when the main scanning resolution and the sub-scanning resolution in reading by the image reading unit 106 are different from each other, it is possible to appropriately determine the reference position for the skew correction, and it is possible to prevent a decrease in correction accuracy of the document image due to the skew correction. Therefore, it is possible to provide a high-quality document image.

### Second Embodiment

In the second embodiment, an example in which the skew correction unit 211 included in the controller 200 in the image reading apparatus 100 performs processing different from that of the first embodiment as skew correction processing with respect to the read image will be described. Hereinafter, description of parts common to the first embodiment are omitted.

The skew correction unit 211 of the present embodiment implements skew correction processing with respect to the read image without performing rotational correction processing and shear correction processing described in the first embodiment. Specifically, the skew correction unit 211 acquires a reference position O′ after correction based on the reference position O obtained by the reference position computation unit 209 and the correction amount (dxP, dyP) obtained by the reference position correction unit 210. The skew correction unit 211 further generates an image after the skew correction by generating an image in which each pixel read from the read image is rearranged so as to convert an image having a parallelogram shape into an image having a rectangular shape with reference to this reference position O′.

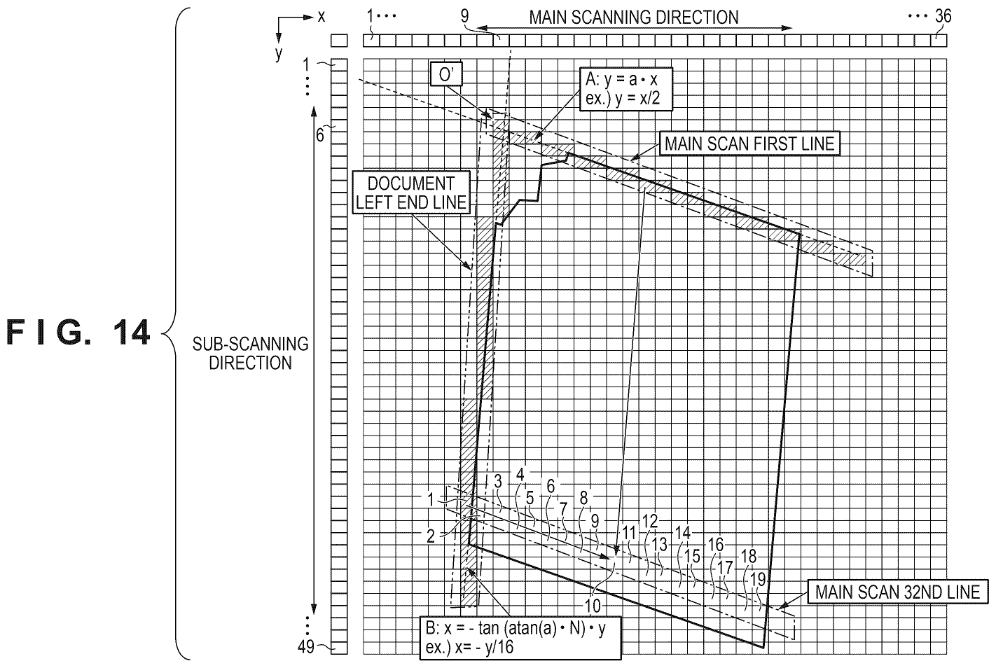

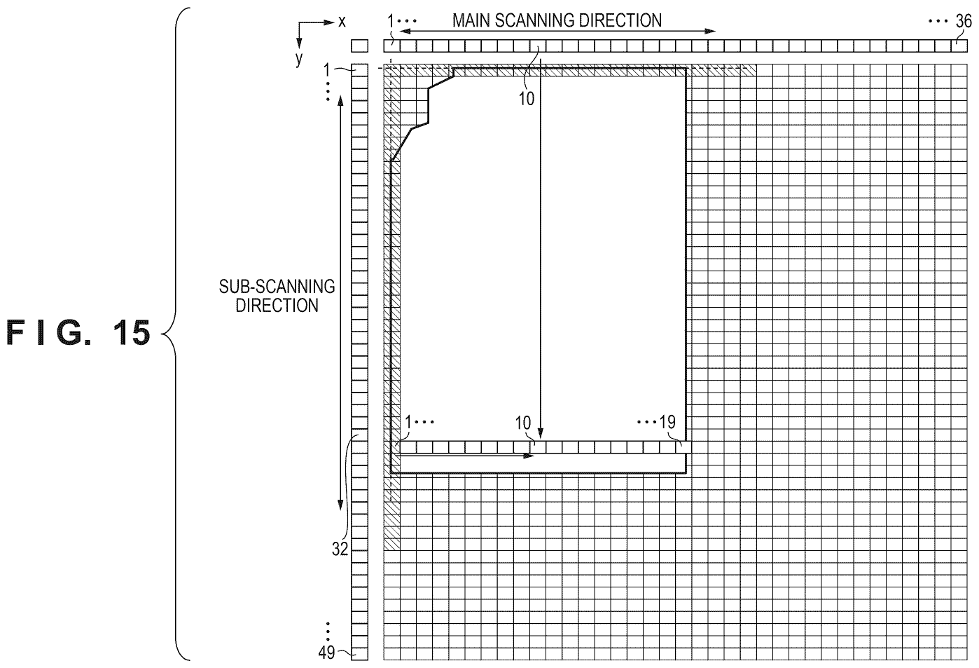

An example of a method of determining a pixel position of a pixel to be read from a read image will be described with reference to FIGS. 14 and 15. FIG. 14 illustrates an example of a read image obtained when a document is read at the main scanning resolution of 300 dpi and the sub-scanning resolution of 600 dpi. FIG. 15 illustrates an example of an image after skew correction obtained by reading, with reference to the reference position O′, pixels constituting the document image in the read image illustrated in FIG. 14 and rearranging the pixels to form a rectangular image.

In the example of FIG. 14, the horizontal axis (x axis) indicates the pixel number in the main scanning direction, the vertical axis (y axis) indicates the pixel number in the sub-scanning direction, and a case is indicated in which the reference position O′ is corrected to coordinates (9, 6) as a result of correcting the reference position O using the correction amount (dxP, dyP). The pixel at the reference position O′ is a pixel at coordinates (1, 1) in FIG. 15.

In the example of FIG. 14, in a case where the reference position O′ is the origin, the linear equation representing the straight line A corresponding to the document leading end is expressed by the following expression using the parameter (inclination a) of the linear equation obtained by the inclination computation unit 208.

$$A : y = a \cdot x \qquad ( 11 )$$

On the other hand, the linear equation representing the straight line B corresponding to the document left end is expressed by the following expression when solved for the horizontal axis (x axis). Note that N is the skew correction coefficient N obtained by the reference position correction unit 210.

$$B : x = tan \{ {tan}^{- 1} ( a ) \cdot N \} \cdot y \qquad ( 12 )$$

### Specification of Pixel Position on Document Left End Line

The skew correction unit 211 first specifies a pixel position on a document left end line indicating the left end of the document image in the read image. This document left end line is associated with the document left end line (a line that is the line of the first pixel in the main scanning direction and is along the sub-scanning direction) in FIG. 15. In the read image, the first pixel on the document left end line is a pixel at the reference position O′ (the pixel in the coordinates (9, 6) in FIG. 14 and the pixel in the coordinates (1, 1) in FIG. 15).

The skew correction unit 211 sequentially obtains the pixel position on the line in the read image from the first pixel on the document left end line. Other pixel positions (i.e., the pixel positions corresponding to the coordinates (1, 2) to (1, 34) in FIG. 15) on the document left end line can be obtained using Expression (12). For example, a case will be described in which the position of the 32nd pixel (i.e., the pixel position corresponding to the coordinates (1, 32) in FIG. 15) in the y axis direction (sub-scanning direction) is obtained from the reference position O′ in a case where the inclination of the straight line B is − 1/16. Substituting y=32 into Expression (12) yields y=−32/16=−2. That is, it is known that the x coordinate of the pixel to be obtained is a position shifted by −2 pixels from the reference position O′. When expressed in the absolute coordinates, the pixel at coordinates (7, 37) in FIG. 14 corresponds to the pixel at the coordinates (1, 32) in FIG. 15.

The skew correction unit 211 can specify the position of the pixel corresponding to one column of the document left end line (the pixel position corresponding to the coordinates (1, 1) to (1, 34) in FIG. 15) by such computation.

### Identification of Pixel Position of Main Scanning Line

Next, the skew correction unit 211 specifies the pixel position on each main scanning line with the pixel on the document left end line (first pixel in the main scanning direction) obtained as described above as a start point. For example, in the case of the main scanning line of the 32nd line, the pixel position of each main scanning line indicates the pixel position corresponding to the pixel of the coordinates (2, 32) to (19, 32) in FIG. 15.

The start point (first pixel) of the line in each main scanning direction is a pixel position on the document left end line. For example, in the case of the main scanning line of the 32nd line, it is the pixel position of the coordinates (7,37) on the document left end line of FIG. 14, which is the pixel position of the 32nd pixel on the document left end line. In order to obtain the other pixel positions in each main scanning line, the y coordinate of the main scanning line with respect to the x coordinate of an arbitrary pixel position in the x axis direction is obtained by substituting the difference in the x axis direction from the first pixel on the main scanning line into Expression (11).

For example, a case where the inclination of the straight line A is ½, and the pixel position of the 10th pixel from the left end (the pixel position corresponding to the pixel at coordinates (10, 32) in FIG. 15) on the main scanning line of the 32nd line will be described. In this case, in FIG. 14, the y coordinate of the 10th pixel in the x axis direction is obtained on the main scanning line of the 32nd line with the 32nd pixel position on the document left end line as the start point (first pixel). Specifically, y=5 is obtained by substituting x=10 into Expression (11). This indicates that in the document image, on the main scanning line of the 32nd line, the pixel position of the 10th pixel from the left end is a position shifted by 10 pixels in the x axis direction and 5 pixels in the y axis direction with the first pixel on the main scanning line of the 32nd line as a start point. That is, when expressed in the absolute coordinates, coordinates (17, 42) in FIG. 14 are the pixel position of the 10th pixel in the main scanning line of the 32nd line.

The skew correction unit 211 can specify the position of the pixel on each main scanning line in the document image (the pixel position corresponding to the coordinates (1, 1) to (1, 34) in FIG. 15) by such computation.

Finally, the skew correction unit 211 forms an image by reading the pixel data of the pixel position specified in the read image to rearrange them into a rectangular shape as illustrated in FIG. 15. By this, an image after correction in which skew correction (rotational correction and shear correction) is performed with respect to the read image is generated.

Note that in the above-described example, the range in the sub-scanning direction (y axis direction) for obtaining the pixel position on the document left end line is 49 pixels, and the second range in the main scanning direction (x axis direction) for obtaining the pixel position on the main scanning line is 36 pixels. The ranges in the sub-scanning direction and the main scanning direction may be determined in advance, or may be determined by detecting the length in the main scanning direction and the length in the sub-scanning direction of the document image in the read image based on the result of detecting the edge portion by the edge detection unit 205.

As described above, in the image reading apparatus (image processing apparatus) of the present embodiment, the skew correction unit 211 specifies the position of each pixel constituting the document image in the read image with reference to the reference position O′, and rearranges the specified pixels in the read image, thereby generating an image on which the skew correction has been performed. This can implement the skew correction processing without performing the rotational correction processing and the shear correction processing (affine transformation).

According to the present disclosure, it is possible to prevent a decrease in correction accuracy of a read image (document image) due to skew correction even when a read resolution in a main scanning direction and a read resolution in a sub-scanning direction are different from each other.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-169198, filed Sep. 27, 2024, which is hereby incorporated by reference herein in its entirety.

What is claimed is:

1. An image processing apparatus comprising:
a detection unit configured to detect an end portion of a document image in a first direction and an end portion of the document image in a second direction orthogonal to the first direction, in a read image obtained by reading a document conveyed in the first direction;
a computation unit configured to determine a reference position for skew correction with respect to the read image by computing a corner position of the document image in the read image based on a result of detection by the detection unit, a first resolution, which is a read resolution in the first direction in reading of the document, and a second resolution, which is a read resolution in the second direction in reading of the document; and
a correction unit configured to perform the skew correction with respect to the read image with reference to the reference position.

2. The image processing apparatus according to claim 1, wherein
the computation unit includes:
a first computation unit configured to determine a first reference position by a first computation based on an edge position of the end portion in the second direction of the document image and a parameter representing a first straight line corresponding to the end portion in the first direction of the document image, which are obtained from the result of the detection; and
a second computation unit configured to determine a correction amount with respect to the first reference position by a second computation based on the edge position, a skew angle of the document image with respect to the second direction, which is obtained from the parameter, and the first resolution and the second resolution, and to determine a second reference position as the reference position for the skew correction by correcting the first reference position with the correction amount.

3. The image processing apparatus according to claim 2, wherein
the computation unit determines the first reference position as the reference position in a case where the first resolution and the second resolution are equal to each other, and
the computation unit determines the second reference position as the reference position in a case where the first resolution and the second resolution are different from each other.

4. The image processing apparatus according to claim 2, wherein
the computation unit performs only computation by the first computation unit without performing computation by the second computation unit in a case where the first resolution and the second resolution are equal to each other.

5. The image processing apparatus according to claim 2, wherein
the second computation unit determines the correction amount to be 0 without performing the second computation in a case where the first resolution and the second resolution are equal to each other.

6. The image processing apparatus according to claim 2, wherein
the first computation unit computes, as the first reference position, an intersection point between a normal with respect to the first straight line, the normal passing through the edge position, and the first straight line.

7. The image processing apparatus according to claim 2, wherein
the second computation unit obtains a position of an intersection point between the first straight line and a second straight line corresponding to the end portion in the second direction of the document image, and determines the correction amount based on a difference between the intersection point and the first reference position.

8. The image processing apparatus according to claim 7, wherein
the second straight line is a straight line passing through the edge position and having an angle with respect to the first direction, the angle being obtained by multiplying a correction coefficient obtained from the first resolution and the second resolution, by the skew angle.

9. The image processing apparatus according to claim 7, wherein
the second computation unit obtains the position of the intersection point by computation based on the edge position, the skew angle, and the correction coefficient obtained from the first resolution and the second resolution.

10. The image processing apparatus according to claim 1, wherein
the correction unit performs rotational correction of rotating the read image with reference to the reference position, and shear correction of converting an image having a parallelogram shape into an image having a rectangular shape with respect to the read image subjected to the rotational correction.

11. The image processing apparatus according to claim 1, wherein
the correction unit generates an image subjected to the skew correction by specifying a position of each pixel constituting the document image in the read image with reference to the reference position and rearranging each pixel specified in the read image.

12. An image reading apparatus comprising:
an image processing apparatus; and
a reading unit configured to read a document conveyed in a first direction to generate a read image,
wherein the image processing apparatus comprises:
a detection unit configured to detect an end portion of a document image in the first direction and an end portion of the document image in a second direction orthogonal to the first direction, in the read image generated by the reading unit;
a computation unit configured to determine a reference position for skew correction with respect to the read image by computing a corner position of the document image in the read image based on a result of detection by the detection unit, a first resolution, which is a read resolution in the first direction in reading of the document, and a second resolution, which is a read resolution in the second direction in reading of the document; and
a correction unit configured to perform the skew correction with respect to the read image with reference to the reference position.
